(19) United States
(12) Patent Application Publication
(10) Pub. No.: US 2024/0353636 A1
(43) Pub. Date: Oct. 24, 2024

(54) PHOTOELECTRIC CONVERSION MODULE PLUG AND OPTICAL CABLE

(71) Applicant: NITTO DENKO CORPORATION, Osaka (JP)

(72) Inventors: Naoyuki TANAKA, Osaka (JP); Seiki TERAJI, Osaka (JP)

(73) Assignee: NITTO DENKO CORPORATION, Osaka (JP)

(21) Appl. No.: 18/684,491

(22) PCT Filed: Aug. 30, 2022
(86) PCT No.: PCT/JP2022/032569

§ 371 Date: Feb. 16, 2024

(30) Foreign Application Priority Data
Aug. 31, 2021 (JP) 2021-141078

(51) Int. Cl. G02B 6/42

(52) U.S. Cl. CPC G02B 6/4278; G02B 6/4262; G02B 6/428

(57) ABSTRACT

A photoelectric conversion module plug includes a PCB, an electrical connector, an opto-electric hybrid board, an optical fiber, a photonic device, and a casing that accommodates them. The opto-electric hybrid board includes a core. The core includes a mirror surface. The electrical connector and the optical fiber are separately arranged in the first direction. The casing includes a first wall and a second wall that face each other at an interval in the thickness direction. The first wall has a first intermediate surface extending in a direction away from the second wall in the thickness direction. The first intermediate surface faces an electrical connector side in an arrangement direction in which the electrical connector and the optical fiber are arranged.

### TECHNICAL FIELD

The present invention relates to a photoelectric conversion module plug and an optical cable.

### BACKGROUND ART

It has been known to transmit optical signals by using an optical cable. The optical cable includes plugs disposed on both ends thereof. Each of the two plugs includes a photoelectric conversion module plug.

For example, a photoelectric conversion module plug including an optical fiber, an electric circuit board, a lens block, and a casing has been proposed (for example, see Patent Document 1 below). In the photoelectric conversion module plug of Patent Document 1, the optical fiber is optically connected to the optical cable.

An electrical connector is provided on one end portion of the electric circuit board. Furthermore, the lens block is mounted on a surface of the electric circuit board. An end portion of the optical fiber is attached to the lens block. The lens block can change the optical axis of the optical signal transmitted from the optical fiber by 90°.

The casing accommodates the optical fiber, the electric circuit board, and the lens block. A part of the electrical connector protrudes from the casing. The part of the electrical connector is inserted into a receiving portion of an external device.

### CITATION LIST

### Patent Document

Patent Document 1: Japanese Unexamined Patent Publication No. 2010-122312

### SUMMARY OF THE INVENTION

### Problem to be Solved by the Invention

The lens block is bulky. A disadvantage thereof is thus that the photoelectric conversion module plug of Patent Document 1 is thick.

A surface of the casing in the photoelectric conversion module plug described in Patent Document 1 is flat. Hence, when the electrical connector is pulled out of the external device, the finger is easily slipped on the surface of the casing when the finger is brought into contact with the surface. Therefore, a disadvantage thereof is thus that the operability of the photoelectric conversion module plug is low.

The present invention provides a photoelectric conversion module plug and an optical cable that are thin and have excellent operability.

### Means for Solving the Problem

The present invention [1] includes a photoelectric conversion module plug comprising: a circuit board; an electrical connector electrically connected to the circuit board and capable of being inserted into an external device; an opto-electric hybrid board disposed one side in a thickness direction of the circuit board and electrically connected to the circuit board; an optical fiber optically connected to the opto-electric hybrid board; a photonic device mounted on the opto-electric hybrid board; and a casing accommodating the circuit board, a part of the electrical connector, the opto-electric hybrid board, a part of the optical fiber, and the photonic device, wherein the opto-electric hybrid board includes a core optically connected to the optical fiber, wherein the core includes a mirror surface optically connected to the photonic device, wherein the electrical connector and the optical fiber are separately arranged in an orthogonal direction to the thickness direction, wherein the casing includes a first wall and a second wall that face each other at an interval in the thickness direction, and wherein the first wall has a surface extending in a direction away from the second wall in the thickness direction and faces the electrical connector side in the arrangement direction.

In the photoelectric conversion module plug, the core optically connected to the optical fiber has the mirror surface. The mirror surface is optically connected to the photonic device. In this manner, in the photoelectric conversion module plug, the optical fiber is optically connected to the core without a lens block therebetween. Thus, the photoelectric conversion module plug can be thinned as compared with the structure of Patent Document 1 including a bulky lens block.

Furthermore, in the photoelectric conversion module plug, the first wall of the casing includes a surface extending in a direction away from the second wall in the thickness direction and facing the electrical connector side in the arrangement direction. Therefore, the connector is easily pulled out of the external device by pressing the fingers to the surface and pulling the casing to the opposite side to the electrical connector. As a result, the photoelectric conversion module plug has excellent operability.

Furthermore, in the photoelectric conversion module plug, the second portion is included in the thick portion, and thus the part of the optical fiber is surely accommodated.

The present invention [2] includes the photoelectric conversion module plug described in the above-described [1], wherein the casing has: a thin portion; and a thick portion thicker than the thin portion, wherein the first wall has: a first portion included in the thin portion and facing a part of the electrical connector in the thickness direction; and a second portion included in the thick portion and facing a part of the optical fiber in the thickness direction, and wherein the surface is disposed between the first portion and the second portion in the orthogonal direction.

The present invention [3] includes the photoelectric conversion module plug described in the above-described [2], wherein a difference in thickness between the thick portion and the thin portion is 0.1 mm or more and 5 mm or less.

When the difference in thickness between the thick portion and the thin portion is 0.1 mm or more, excellent holdability on the first wall and excellent handleability of the photoelectric conversion module plug are achieved. When the difference in thickness between the thick portion and the thin portion is 5 mm or less, the photoelectric conversion module plug can be thinned.

The present invention [4] includes the photoelectric conversion module plug described in the above-described [1] or [2], further comprising: a boot that attaches a cable having the optical fiber to the casing, wherein the boot faces the second portion in the thickness direction.

In the photoelectric conversion module plug, the second portion can surely accommodate the boot.

The present invention [5] includes the photoelectric conversion module plug in any one of the above-described [2] to [4], wherein the first portion has a first surface facing in the away direction, and wherein a connecting portion of the first surface and the surface has a curved surface.

In the photoelectric conversion module plug, the connecting portion has the curved surface, and thus its rigidity can be improved as compared with a structure without a curved surface.

The present invention [6] includes the photoelectric conversion module plug described in any one of the above-described [2] to [5], wherein the second portion has a second surface facing in the away direction, and wherein a connecting portion of the second surface and the surface has a curved surface.

In the photoelectric conversion module plug, the connecting portion has the curved surface, and thus its rigidity can be improved as compared with a structure without a curved surface.

The present invention [7] includes the photoelectric conversion module plug described in the above-described [5] or [6], wherein the curved surface has a radius of curvature of 1 μm or more and 50 mm or less.

When the connecting portion has a radius of curvature of 1 μm or more, the rigidity of the connecting portion can be increased.

The present invention [8] includes the photoelectric conversion module plug described in any one of the above-described [1] to [7], wherein the second wall has a surface extending in a direction away from the first wall in the thickness direction and facing the electrical connector side in the arrangement direction.

The present invention [9] includes the photoelectric conversion module plug described in any one of the above-described [1] to [8], wherein the the casing has two side walls joining both end portions in a width direction orthogonal to the thickness direction and the away directions of the first wall and the second wall, and wherein the two side walls has a concave portion and/or a convex portion.

Fingers are easily kept on the two side walls of the casing of the photoelectric conversion module plug. Thus, the operability of the photoelectric conversion module plug can be improved.

The present invention [10] includes an optical cable comprising: two photoelectric conversion module plugs; and a cable that optically connects the two photoelectric conversion module plugs, wherein at least one of the two photoelectric conversion module plugs is the photoelectric conversion module plug in any one of the above-described [1] to [9].

### Effects of the Invention

The photoelectric conversion module plug and optical cable of the present invention are thin and have excellent operability.

### BRIEF DESCRIPTION OF THE DRAWINGS

FIG. 1 is a plan view of one embodiment of the photoelectric conversion module plug of the present invention.

FIG. 2 is a cross-sectional view of the photoelectric conversion module plug shown in FIG. 1.

FIG. 3 is a partially enlarged cross-sectional view of the photoelectric conversion module plug shown in FIG. 2.

FIG. 4 shows an optical cable including the photoelectric conversion module plug shown in FIG. 1.

FIG. 5 shows a second variation of the photoelectric conversion module plug shown in FIG. 2.

FIG. 6 shows a third variation of the photoelectric conversion module plug shown in FIG. 2.

FIGS. 7A to 7C show a fifth variation of the photoelectric conversion module plug.

FIGS. 8A to 8D show a sixth variation of the photoelectric conversion module plug.

### DESCRIPTION OF THE EMBODIMENT

### 1. One Embodiment of Photoelectric Conversion Module Plug and Optical Cable

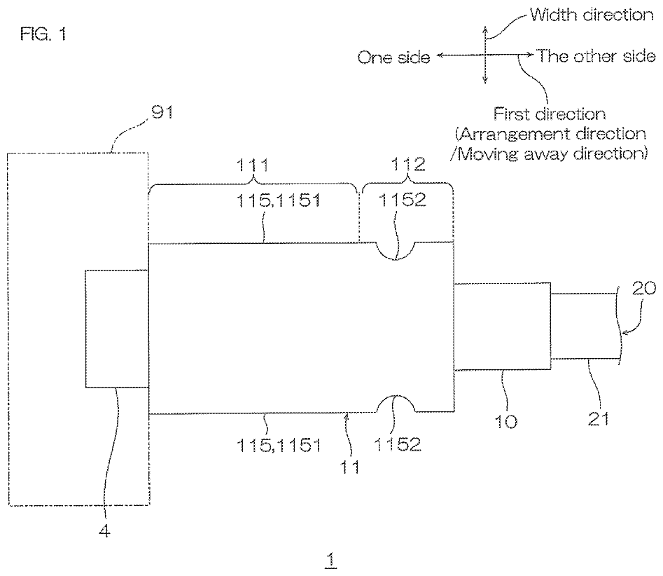

One embodiment of the photoelectric conversion module plug and optical cable of the present invention is described with reference to FIG. 1 to FIG. 4.

### 1.1 Photoelectric Conversion Module Plug 1 and Optical Cable 2

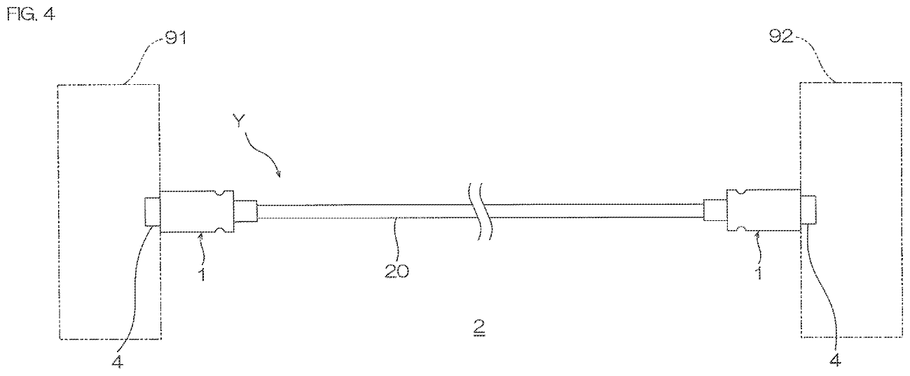

As shown in FIG. 4, a photoelectric conversion module plug 1 is disposed on each of both ends of the optical cable 2. Each of the two photoelectric conversion module plugs 1 is connected to each of a first device 91 and a second device 92. Examples of the first device 91 include an image display device. Examples of the second device 92 include an image output device and an image record device.

The two photoelectric conversion module plugs 1 have the same structure. A photoelectric conversion module plug 1 connected to the first device 91 is described below.

### 1.2 Structure of Photoelectric Conversion Module Plug 1

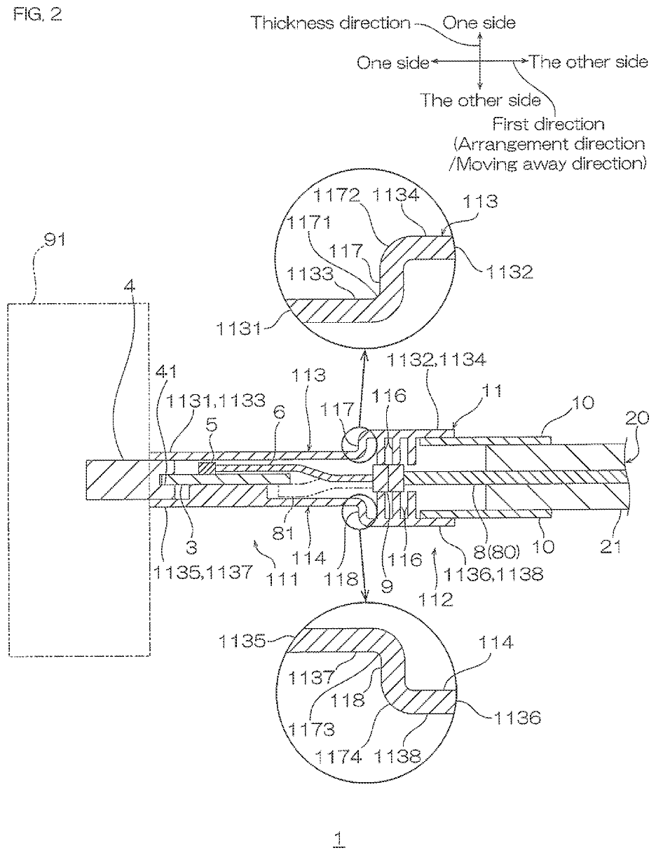

As shown in FIG. 1 and FIG. 2, the photoelectric conversion module plug 1 has a shape extending in a first direction when being connected to the above-described first device 91. The first direction is an example of a direction orthogonal to a thickness direction described below. Further, the photoelectric conversion module plug 1 has the shape of a flat plate having a thickness. The thickness is orthogonal to the extending direction. Furthermore, the photoelectric conversion module plug 1 has a length in a width direction orthogonal to the first direction and the thickness direction. The above-described length in the width direction of the photoelectric conversion module plug 1 is a width. The width of the photoelectric conversion module plug 1 is, for example, 4 mm or more and, for example, 30 mm or less, preferably 15 mm or less. The ratio (width/thickness) of the width to the thickness is, for example, 1 or more, preferably 2 or more, more preferably and, for example, 50 or less, preferably 5 or less. The photoelectric conversion module plug 1 includes a PCB 3 as an example of a circuit board, an electrical connector 4, a board connector 5, an opto-electric hybrid board 6, a photonic device 7, an optical fiber 8, an optical connector 9, a boot 10, and a casing 11.

### 1.3 PCB 3

As shown in FIG. 2, the PCB 3 is disposed on one end portion in the first direction of the photoelectric conversion module plug 1. The PCB 3 has the shape of a flat plate. The PCB 3 extends in the first direction. The PCB 3 is a printed circuit board. The PCB 3 includes a hard board (not shown) of an insulating layer and an electrically conductive layer (not shown) in sequence in the thickness direction.

### 1.4 Electrical Connector 4

The electrical connector 4 is disposed on one end portion of the PCB 3 in the first direction. The electrical connector 4 has the shape of a flat plate. The electrical connector 4 extends in the first direction. The electrical connector 4 has a receiving portion 41. The receiving portion 41 has an approximately U shape in the cross-sectional view. The one end portion of the PCB 3 in the first direction is inserted into the receiving portion 41. In this manner, the electrical connector 4 is electrically connected to the PCB 3. Furthermore, a part of the electrical connector 4 in the first direction can be inserted into the first device 91 (and the second device 92).

### 1.5 Board Connector 5

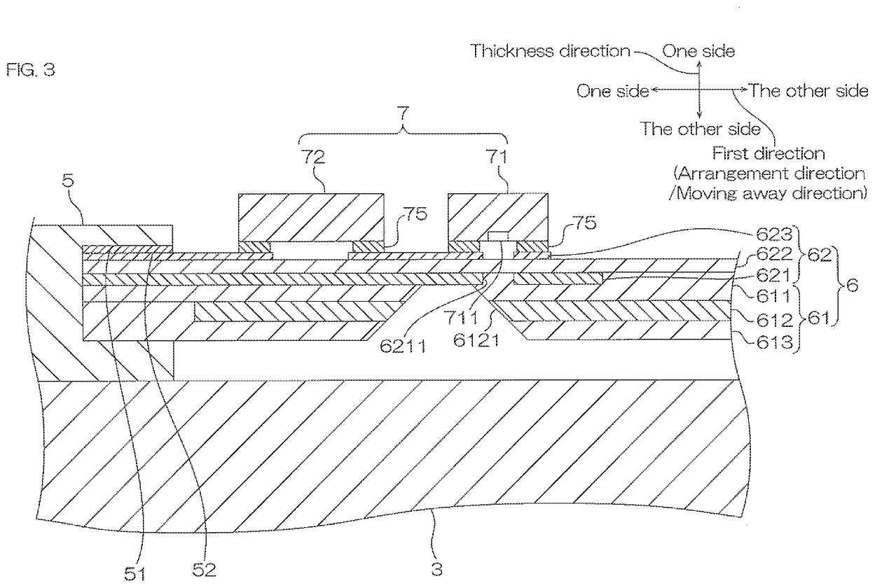

The board connector 5 is disposed on one end portion in the first direction of the one surface in the thickness direction of the PCB 3. The board connector 5 is mounted on one surface in the thickness direction of the PCB 3. In this manner, the board connector 5 is electrically connected to the PCB 3. The board connector 5 has an approximately U shape in the cross-sectional view. As shown in FIG. 3, the board connector 5 has a board receiving portion 51. The board receiving portion 51 opens toward the other side of the first direction. A conductive layer 52 is provided on an internal surface of the board receiving portion 51.

### 1.6 Opto-Electric Hybrid Board 6

The opto-electric hybrid board 6 is disposed at one side in the thickness direction of the PCB 3. The opto-electric hybrid board 6 extends in the first direction. The opto-electric hybrid board 6 has the shape of a flat belt. One end portion in the first direction of the opto-electric hybrid board 6 is received in the board receiving portion 51 of the board connector 5. The opto-electric hybrid board 6 includes an optical waveguide 61 and an electric circuit board 62 in sequence toward one side in the thickness direction.

### 1.6.1 Optical Waveguide 61

The optical waveguide 61 is disposed at the other side in the thickness direction of the opto-electric hybrid board 6. The optical waveguide 61 forms the other surface in the thickness direction of the opto-electric hybrid board 6. The optical waveguide 61 extends in the first direction. The optical waveguide 61 has the shape of a flat belt. Examples of the material of the optical waveguide 61 include resin. The optical waveguide 61 has a thickness of, for example, 10 μm or more, and, for example, 500 μm or less, preferably 200 μm or less. The optical waveguide 61 has an under-cladding 611, a core 612, and an over-cladding 613 toward the other side in the thickness direction.

### 1.6.1.1 Under-Cladding 611

The under-cladding 611 forms one surface in the thickness direction of the optical waveguide 61.

### 1.6.1.2 Core 612

The core 612 is disposed on the other surface in the thickness direction of the under-cladding 611. Specifically, the core 612 is in contact with an intermediate portion in the width direction of the other surface in the thickness direction of the under-cladding 611. The core 612 has a higher refractive index than that of the under-cladding 611. Further, the core 612 has a mirror surface 6121. The mirror surface 6121 is disposed on one end portion in the first direction of the core 612. The mirror surface 6121 is inclined relative to the first direction by 40° to 50°.

### 1.6.1.3 Over-Cladding 613

The over-cladding 613 is disposed on the other surface in the thickness direction of the under-cladding 611 so as to cover the core 612. Specifically, the over-cladding 613 is in contact with the other surface in the thickness direction of the under-cladding 611 on the periphery of the core 612 and with the other surface in the thickness direction and two side surfaces (both end surfaces in the width direction) of the core 612. The over-cladding 613 has a lower refractive index than that of the core 612.

### 1.6.2 Electric Circuit Board 62

The electric circuit board 62 is disposed at one side in the thickness direction of the opto-electric hybrid board 6. The electric circuit board 62 is in contact with the one surface in the thickness direction of the optical waveguide 61. The electric circuit board 62 forms one surface in the thickness direction of the opto-electric hybrid board 6. The electric circuit board 62 extends in the first direction. The electric circuit board 62 has the shape of a flat belt. The electric circuit board 62 has a thickness of, for example, 5 μm or more, and, for example, 500 μm or less, preferably 200 μm or less. The electric circuit board 62 includes a metal supporting layer 621, an insulating layer 622, and a conductive layer 623 in sequence toward one side in the thickness direction.

### 1.6.2 Metal Supporting Layer 621

The metal supporting layer 621 is disposed on the one end portion of the electric circuit board 62 in the first direction. The metal supporting layer 621 includes a penetrating hole 6211. The other surface in the first direction of the metal supporting layer 621 and the internal surface in the penetrating hole 6211 are in contact with the under-cladding 611. The penetrating hole 6211 overlaps with the above-described mirror surface 6121 when being projected in the thickness direction. Examples of the material of the metal supporting layer 621 include a metal. Examples of the metal include a stainless steel.

### 1.6.2. Insulating Layer 622

The insulating layer 622 is disposed on one surface in the thickness direction of the metal supporting layer 621. The insulating layer 622 is disposed on the entire electric circuit board 62 in the first direction. Examples of the material of the insulating layer 622 include resin. Examples of the resin include polyimide.

### 1.6.2. Conductive Layer 623

The conductive layer 623 is disposed on one end portion of the insulating layer 622 in the first direction. Specifically, the conductive layer 623 is disposed in a region in which the metal supporting layer 621 is disposed. In this manner, the conductive layer 623 is reinforced by the metal supporting layer 621. The conductive layer 623 is disposed on one surface in the thickness direction of the insulating layer 622. The conductive layer 623 has a conductive pattern. The conductive pattern includes a plurality of terminals and wires. One of the terminals is brought into contact with the conductive layer 52 when the opto-electric hybrid board 6 is inserted into the board connector 5. In this manner, the opto-electric hybrid board 6 is electrically connected to the PCB 3. The wire electrically connects the terminals. Examples of the material of the conductive layer 623 include a metal. Examples of the metal include copper.

### 1.7 Photonic Device 7

The photonic device 7 is disposed at one side in the thickness direction of the opto-electric hybrid board 6. The photonic device 7 is mounted on the opto-electric hybrid board 6 so as to overlap with the metal supporting layer 621 in the thickness direction. The photonic device 7 has an approximately rectangular shape in the cross-sectional view. The photonic device 7 is electrically connected to the terminal of the conductive layer 623 through the conductive member 75 provided on the other surface in the thickness direction of the photonic device 7. The photonic device 7 includes a light emitting/receiving element 71 and a circuit 72.

### 1.7.1 Light Emitting/receiving Element 71

The light emitting/receiving element 71 is disposed at the other side in the first direction in the photonic device 7. The light emitting/receiving element 71 has an aperture 711 disposed on the other surface in the thickness direction of the light emitting/receiving element 71. The aperture 711 overlaps with the mirror surface 6121 when projected in the thickness direction. Examples of the light emitting/receiving element 71 include a vertical cavity surface-emitting laser diode (VCSEL) and a photodiode (PD). When the light emitting/receiving element 71 is a VCSEL, the aperture 711 is a light emitting aperture. When the light emitting/receiving element 71 is a PD, the aperture 711 is a light entering aperture.

### 1.7.2 Circuit 72

The circuit 72 is disposed at one side in the thickness direction relative to the light emitting/receiving element 71. The circuit 72 is electrically connected to the light emitting/receiving element 71 through the above-described conductive layer 623. Examples of the circuit 72 include a drive integrated circuit (drive IC) and a transimpedance amplifier circuit (TIA). The drive IC drives the VCSEL. The TIA amplifies the electricity of the PD.

### 1.8 Optical Fiber 8

As shown in FIG. 2, the optical fiber 8 is included in the photoelectric conversion module plug 1 and also in the optical cable 2. One end portion of the optical fiber 8 is disposed in the other end portion in the first direction of the photoelectric conversion module plug 1. The one end portion of the optical fiber 8 is located adjacently to the opto-electric hybrid board 6 in the first direction. Furthermore, the one end portion of the optical fiber 8 is arranged separately from the electrical connector 4 in the first direction. In other words, the above-described first direction is a direction in which the optical fiber 8 is separated from the electrical connector 4. The optical fiber 8 has, for example, an approximately circular shape in a cross-sectional view.

### 1.9 Optical Connector 9

The optical connector 9 is disposed on the other end portion in the first direction of the photoelectric conversion module plug 1. The optical connector 9 is disposed between the optical fiber 8 and the opto-electric hybrid board 6 in the first direction. The optical connector 9 optically connects the optical fiber 8 to the optical waveguide 61 of the opto-electric hybrid board 6 (the core 612, see FIG. 3). In other words, the optical fiber 8 is optically connected to the opto-electric hybrid board 6 through the optical connector 9. The optical connector 9 has an approximately rectangular shape in the cross-sectional view. The optical connector 9 is thicker than the opto-electric hybrid board 6 and the optical fiber 8.

### 1.10 Boot 10

The boot 10 is disposed on the other end portion in the first direction of the photoelectric conversion module plug 1. Specifically, the boot 10 is disposed at the other side of the optical connector 9 in the first direction. The boot 10 extends in the first direction. The boot 10 has an approximately tubular shape. The other end portion in the first direction of the boot 10 is separated from the optical fiber 8 by an interval in a radial direction. The one end portion in the first direction of the boot 10 is disposed on the other end portion in the first direction of the photoelectric conversion module plug 1.

### 1.11 Casing 11

The casing 11 accommodates the PCB 3, a part of the electrical connector 4, the board connector 5, the opto-electric hybrid board 6, the photonic device 7, a part of the optical fiber 8, the optical connector 9, and a part of the boot 10. Examples of the material of the casing 11 include resin. The casing 11 includes a thin portion 111 and a thick portion 112 in sequence in the first direction. Furthermore, the casing 11 includes a first wall 113, a second wall 114, and two side walls 115 (see FIG. 1).

### 1.11.1 Thin Portion 111

As shown in FIG. 1, the thin portion 111 is one side portion in the first direction of the casing 11. As shown in FIG. 2, the thin portion 111 accommodates, for example, at least the part of the electrical connector 4. The thin portion 111 preferably accommodates the PCB 3, the part of the electrical connector 4, the board connector 5, a part of the opto-electric hybrid board 6, and the photonic device 7 (see FIG. 3). The remainder of the electrical connector 4 (one side portion in the first direction) protrudes from the thin portion 111 toward one side in the first direction. The thin portion 111 has a thickness of, for example, 7 mm or less, preferably 5 mm or less, and, for example, 1 mm or more.

### 1.11.2 Thick Portion 112

The thick portion 112 is the other side portion in the first direction of the casing 11. The thick portion 112 is adjacent to the other side in the first direction of the thin portion 111. The thick portion 112 is disposed at a side opposite to the electrical connector 4 relative to the thin portion 111 in the first direction.

The thick portion 112 accommodates, for example, at least the part of the optical fiber 8. For example, the thick portion 112 accommodates a part of the optical fiber 8, the optical connector 9, and the part of the boot 10. The cable 20 is attached to the thick portion 112 through the boot 10.

The thick portion 112 is thicker than the thin portion 111. The difference in thickness between the thick portion 112 and the thin portion 111 is, for example, 0.1 mm or more, preferably 1 mm or more, and, for example, 5 mm or less, preferably 3 mm or less. When the above-described difference is the above-described lower limit or more, excellent holdability on the first wall 113 and excellent handleability of the photoelectric conversion module plug 1 are achieved. When the above-described difference is the above-described upper limit or less, the photoelectric conversion module plug 1 can be thinned.

The thick portion 112 has a thickness of, for example, 3 mm or more, preferably 5 mm or more, and, for example, 15 mm or less.

### 1.11.3 First Wall 113

The first wall 113 is disposed at one side in the thickness direction of the casing 11. The first wall 113 forms one surface in the thickness direction of the casing 11. The first wall 113 has the shape of a flat plate. The first wall 113 extends in the first direction and the width direction.

Furthermore, the first wall 113 includes a first portion 1131 and a second portion 1132 in sequence toward the other side of the first direction.

The first portion 1131 is included in the above-described thin portion 111. The first portion 1131 faces, for example, at least the part of the electrical connector 4 in the thickness direction. In the thickness direction, the first portion 1131 preferably faces the PCB 3, the part of the electrical connector 4, the board connector 5, the part of the opto-electric hybrid board 6, the photonic device 7, and a part of the optical fiber 8. The first portion 1131 includes a first surface 1133. The first surface 1133 forms the above-described one surface of the first wall 113.

The second portion 1132 is included in the above-described thick portion 112. Furthermore, the second portion 1132 faces, for example, at least the part (one side portion in the first direction) of the boot 10 in the thickness direction. The second portion 1132 preferably faces the part of the optical fiber 8, the optical connector 9, and the part of the boot 10. The second portion 1132 faces the part of the optical fiber 8 in the thickness direction. The second portion 1132 includes a second surface 1134 and an internal surface.

The second surface 1134 forms the above-described one surface of the first wall 113.

A plurality of ribs 116 is provided on the internal surface. The internal surface is an opposite side surface to the above-described one surface. The plurality of the rib 116 extends in the thickness direction. The other surface in the thickness direction of the rib 116 is in contact with the one surface in the thickness direction of the optical connector 9.

### 1.11.4 Second Wall 114

The second wall 114 is disposed on the other side in the thickness direction of the casing 11. The second wall 114 is located at the other side in the thickness direction, facing the first wall 113 at an interval. The second wall 114 forms the other surface in the thickness direction of the casing 11. The second wall 114 has the shape of a flat plate. The second wall 114 extends in the first direction and the width direction.

Furthermore, the second wall 114 includes a third portion 1135 and a fourth portion 1136 in sequence toward the other side in the first direction.

The third portion 1135 is included in the above-described thin portion 111. The third portion 1135 faces, for example, at least the part of the electrical connector 4 in the thickness direction. In the thickness direction, the third portion 1135 preferably faces the PCB 3, the part of the electrical connector 4, the board connector 5, the part of the opto-electric hybrid board 6, the photonic device 7, and a part of the optical fiber 8. In this manner, in the thickness direction, the PCB 3, a part of the electrical connector 4, the board connector 5, a part of the opto-electric hybrid board 6, the photonic device 7, and a part of the optical fiber 8 are disposed between the third portion 1135 and the first portion 1131. The third portion 1135 includes the third surface 1137. The third surface 1137 forms the above-described other surface of the second wall 114.

The fourth portion 1136 is included in the above-described thick portion 112. The fourth portion 1136 faces a part of the optical fiber 8 in the thickness direction. The fourth portion 1136 includes a fourth surface 1138 and an internal surface.

The fourth surface 1138 forms the above-described other surface of the second wall 114.

A plurality of ribs 116 is provided on the internal surface. The internal surface is an opposite side surface to the above-described other surface and faces the internal surface of the first wall 113. The rib 116 of the second wall 114 is disposed at the same position as the rib 116 of the first wall 113 in the first direction. The plurality of ribs 116 extends in the thickness direction. The one surface in the thickness direction of the rib 116 is in contact with the other surface in the thickness direction of the optical connector 9.

### 1.11.5 Two Side Walls 115

As shown in FIG. 1, each of the two side walls 115 joins each of both end portions in the width direction of the first wall 113 (see FIG. 2) to each of both end portions in the width direction of the second wall 114 (see FIG. 2). Each of the two side walls 115 has the shape of a flat plate. Each of the two side walls 115 extends in the first direction.

### 1.11.6 First Intermediate Surface 117 of First Wall 113, Second Intermediate Surface 118 of Second Wall 114, and Concave Portion 1152 of Side Wall 115

In this photoelectric conversion module plug 1, as shown in FIG. 2, the first wall 113 has a first intermediate surface 117 as an example of a surface. The second wall 114 has a second intermediate surface 118 as an example of a surface. As shown in FIG. 1, each of the two side walls 115 has a concave portion 1152.

### 1.11.7 First Intermediate Surface 117

As shown in FIG. 2, the first intermediate surface 117 is included in the first wall 113. The first intermediate surface 117 is disposed between the thin portion 111 and the thick portion 112 in the first direction (i.e., corresponding to a direction in which the electrical connector 4 is separated from the optical fiber 8). Specifically, the first intermediate surface 117 is disposed between the first surface 1133 of the first portion 1131 and the second surface 1134 of the second portion 1132 to join them. The first intermediate surface 117 extends from the first surface 1133 in a direction away from the second wall 114 in the thickness direction and reaches the second surface 1134. Furthermore, the first intermediate surface 117 faces an electrical connector 4 side in the first direction.

The first intermediate surface 117 has a length of, for example, 0.1 mm or more, preferably 1 mm or more, and, for example, 5 mm or less, preferably 3 mm or less.

The first connecting portion 1171 of the first intermediate surface 117 and the first surface 1133 is, for example, a curved surface. The first connecting portion 1171 has a radius of curvature of, for example, 1 μm or more, preferably 100 μm or more, and, for example, 50 mm or less, preferably 10 mm or less. When the radius of curvature of the first connecting portion 1171 is the above-described lower limit or more, the rigidity of the first connecting portion 1171 can be increased.

The second connecting portion 1172 of the first intermediate surface 117 and the second surface 1134 is, for example, a curved surface. The second connecting portion 1172 has a radius of curvature of, for example, 1 μm or more, preferably 100 μm or more, and, for example, 50 mm or less, preferably 10 mm or less. When the radius of curvature of the second connecting portion 1172 is the above-described lower limit or more, the rigidity of the second connecting portion 1172 can be increased. When the radius of curvature of the second connecting portion 1172 is the above-described upper limit or less, excellent holdability on the first wall 113 and excellent handleability of the photoelectric conversion module plug 1 are achieved.

### 1.10.8 Second Intermediate Surface 118

The second intermediate surface 118 is included in the second wall 114. The second intermediate surface 118 is disposed between the thin portion 111 and the thick portion 112 in the first direction. Specifically, the second intermediate surface 118 is disposed between the third surface 1137 of the third portion 1135 and the fourth surface 1138 of the fourth portion 1136 to join them. The second intermediate surface 118 extends from the third surface 1137 in a direction away from the first wall 113 in the thickness direction and reaches the fourth surface 1138. Furthermore, the second intermediate surface 118 faces the electrical connector 4 side in the first direction (the arrangement direction in which the electrical connector 4 and the optical fiber 8 are arranged).

The second intermediate surface 118 has a length identical to that of the first intermediate surface 117.

The third connecting portion 1173 of the second intermediate surface 118 and the third surface 1137 is, for example, a curved surface. The third connecting portion 1173 has a radius of curvature of, for example, 1 μm or more, preferably 100 μm or more, and, for example, 50 mm or less, preferably 10 mm or less. When the radius of curvature of the third connecting portion 1173 is the above-described lower limit or more, the rigidity of the third connecting portion 1173 can be increased.

The fourth connecting portion 1174 of the second intermediate surface 118 and the fourth surface 1138 is, for example, a curved surface. The fourth connecting portion 1174 has a radius of curvature of, for example, 1 μm or more, preferably 100 μm or more, and, for example, 50 mm or less, preferably 10 mm or less. When the radius of curvature of the fourth connecting portion 1174 is the above-described lower limit or more, the rigidity of the fourth connecting portion 1174 can be increased. When the radius of curvature of the fourth connecting portion 1174 is the above-described upper limit or less, excellent holdability on the second wall 114 and excellent handleability of the photoelectric conversion module plug 1 are achieved.

### 1.10.9 Concave Portion 1152

As shown in FIG. 1, the concave portion 1152 is provided on the side surface 1151 of the side wall 115. Each of the two side surfaces 1151 faces the outside in the width direction. The side surface 1151 is an external surface. The concave portion 1152 is disposed, for example, on the thick portion 112 of the side surface 1151. The concave portion 1152 curves inwardly toward the inside in the width direction. The concave portion 1152 has an approximately arc (semicircular arc) shape in the plan view. The concave portion 1152 opens toward the outside in the width direction. Each of the concave portions 1152 is provided on each of the two side surfaces 1151.

### 1.12 Optical Cable 2

Next, an optical cable 2 including the above-described photoelectric conversion module plug 1 is described with reference to FIG. 4.

The optical cable 2 is a cable for transmitting optical signals. Examples of the optical cable 2 include an HDMI (High-Definition Multimedia Interface) transmission cable or a USB Type-C transmission cable. The optical cable 2 includes two photoelectric conversion module plugs 1 described above and a cable 20.

### 1.12.1 Photoelectric Conversion Module Plug 1

The two photoelectric conversion module plugs 1 are disposed at both end portions of the optical cable 2.

One of the photoelectric conversion module plugs 1 is connected to the first device 91. Specifically, the electrical connector 4 in one of the photoelectric conversion module plug 1 is inserted into the aperture of the first device 91.

The other photoelectric conversion module plug 1 is connected to the second device 92. Specifically, the electrical connector 4 in the other photoelectric conversion module plug 1 is inserted in the aperture of the second device 92.

### 1.12.2 Cable 20

The cable 20 connects the two photoelectric conversion module plugs 1. The cable 20 includes the optical fiber 8 and a covering material 21.

### 1.12.2.1 Optical Fiber 8

As shown in FIG. 2, each of both end portions of the optical fiber 8 is accommodated in the casing 11 of each of the two photoelectric conversion module plugs 1. Each of both end portions of the optical fiber 8 is fixed to the casing 11 with a boot 10.

### 1.12.2.2 Covering Material 21

The covering material 21 covers an intermediate portion (between both end portions) of the optical fiber 8.

### 3. Operations and Effects of One Embodiment

In the photoelectric conversion module plug 1, the core 612 optically connected to the optical fiber 8 has the mirror surface 6121, and the mirror surface 6121 is optically connected to the photonic device 7.

In this manner, in the photoelectric conversion module plug 1, the optical fiber 8 is optically connected to the core 612 without a lens block therebetween. Hence, the photoelectric conversion module plug 1 can be thinned as compared with a structure of Patent Document 1 including a large lens block.

Furthermore, in the photoelectric conversion module plug 1, the first wall 113 of the casing 11 has the first intermediate surface 117 extending in the direction away from the second wall 114 in the thickness direction. The first intermediate surface 117 faces the electrical connector side in the arrangement direction of the electrical connector 4 and the optical fiber 8. Thus, by pressing the finger to the first intermediate surface 117 and pulling the casing 11 to the opposite side to the electrical connector (i.e., to the other side in the first direction), the electrical connector 4 can easily be pulled from the first device 91. As a result, the photoelectric conversion module plug 1 has excellent operability.

Furthermore, in the photoelectric conversion module plug 1, the second portion 1132 is included in the thick portion 112. Thus, the part of the optical fiber 8 can surely be accommodated.

When the difference in thickness between the thick portion 112 and the thin portion 111 is 0.1 mm or more, excellent holdability on the first wall 113 and excellent handleability of the photoelectric conversion module plug 1 are achieved. When the difference in thickness between the thick portion 112 and the thin portion 111 is 5 mm or less, the photoelectric conversion module plug 1 can be thinned.

In the photoelectric conversion module plug 1, the second portion 1132 can surely accommodate the boot 10.

In the photoelectric conversion module plug 1, the first connecting portion 1171 has a curved surface. Thus, the rigidity of the first connecting portion 1171 can be improved as compared with a structure without a curved surface.

In the photoelectric conversion module plug 1, the fourth connecting portion 1174 has a curved surface. Thus, the rigidity of the fourth connecting portion 1174 can be improved as compared with a structure without a curved surface.

When the radius of curvature of each of the first connecting portion 1171 and the second connecting portion 1172 is 1 μm or more, the rigidity of each of the first connecting portion 1171 and the second connecting portion 1172 can be increased. When the radius of curvature of each of the first connecting portion 1171 and the second connecting portion 1172 is 50 mm or less, excellent holdability on the first wall 113 and the second wall 114 and excellent handleability of the photoelectric conversion module plug 1 are achieved.

Furthermore, in the photoelectric conversion module plug 1, the two side walls 115 have concave portions 1152. Thus, fingers are easily kept on the two side walls 115. Therefore, the operability of the photoelectric conversion module plug 1 can be improved.

The optical cable 2 includes the above-described two photoelectric conversion module plugs 1, and thus is thin and has excellent operability.

### 4. Variations

In the variations, the same members and steps as the above-described embodiment are given the same numerical references, and the descriptions thereof are omitted. Further, the variations have the same operations and effects as those of the embodiment unless especially described otherwise. The embodiment and variations can appropriately be combined.

### 4.1 First Variation

In the first variation, as shown with solid lines and phantom lines of FIG. 2, the optical fiber 8 may be a hybrid line 80. The hybrid line 80 includes the above-described optical fiber 8 (solid line) and the electric wire 81 (phantom line).

The electric wire 81 is electrically connected to the PCB 3 without an optical connector 9 therebetween. The one end portion in the first direction of the electric wire 81 is electrically connected to the conductive layer formed on the other surface in the thickness direction of the PCB 3.

### 4.2 Second Variation

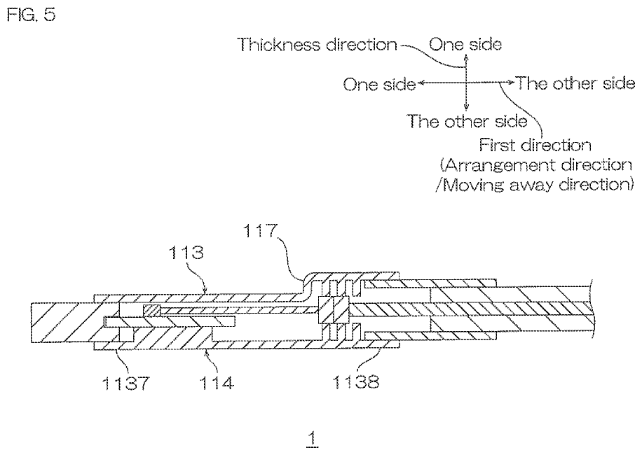

In the second variation, as shown in FIG. 5, the second wall 114 does not have a second intermediate surface 118 (see FIG. 2). In the second wall 114, the third surface 1137 and the fourth surface 1138 form one flat surface.

### 4.3 Third Variation

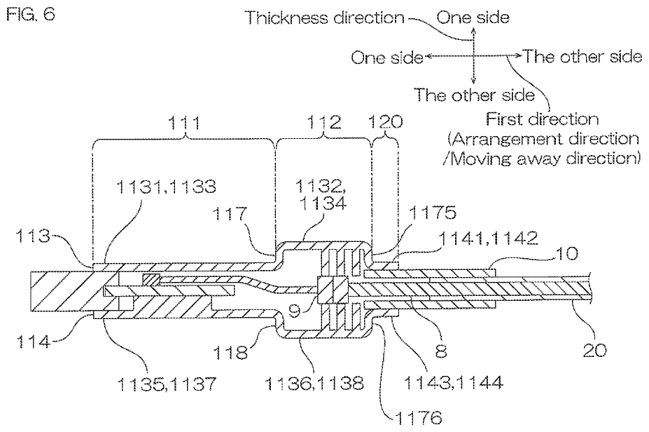

In the third variation, as shown in FIG. 6, the casing 11 further includes a second thin portion 120. The second thin portion 120 is disposed at a side opposite to the thin portion 111 relative to the thick portion 112 in the first direction. In this manner, the thin portion 111, the thick portion 112, and the second thin portion 120 are disposed in sequence toward the other side in the first direction.

### 4.3.1 First Wall 113

The first wall 113 further includes a first rear end portion 1141. The first rear end portion 1141 is disposed at a side opposite to the first portion 1131 relative to the second portion 1132 in the first direction. In this manner, in the first wall 113, the first portion 1131, the second portion 1132, and the first rear end portion 1141 are disposed in sequence toward the other side in the first direction. The first rear end portion 1141 has an external surface 1142.

The second portion 1132 faces the optical connector 9 in the thickness direction. The first rear end portion 1141 faces a part of the boot 10 in the thickness direction.

Then, the first wall 113 has a rear end side first intermediate surface 1175 in addition to the first intermediate surface 117. The rear end side first intermediate surface 1175 is separated from the first intermediate surface 117 by an interval at the other side in the first direction. The rear end side first intermediate surface 1175 is disposed between the second surface 1134 and the external surface 1142. The rear end side first intermediate surface 1175 faces the other side in the first direction. The rear end side first intermediate surface 1175 is disposed between the thick portion 112 and the second thin portion 120 in the first direction.

### 4.3.2 Second Wall 114

The second wall 114 further includes a second rear end portion 1143. The second rear end portion 1143 is disposed at a side opposite to the third portion 1135 relative to the fourth portion 1136 in the first direction. In this manner, on the second wall 114, the third portion 1135, the fourth portion 1136, and the second rear end portion 1143 are disposed in sequence toward the other side in the first direction. The second rear end portion 1143 has an external surface 1144.

Then, the second wall 114 has a rear end side second intermediate surface 1176 in addition to the second intermediate surface 118. The rear end side second intermediate surface 1176 is separated from the second intermediate surface 118 by an interval at the other side in the first direction. The rear end side second intermediate surface 1176 faces the other side in the first direction. The rear end side second intermediate surface 1176 is disposed between the thick portion 112 and the second thin portion 120 in the first direction.

By pressing fingers to the first connecting portion 1171 and/or the second connecting portion 1172 of the photoelectric conversion module plug 1 and pushing the casing 11 into the electrical connector side, the electrical connector 4 can easily be inserted into the aperture of the first device 91. As a result, the photoelectric conversion module plug 1 has excellent operability.

### 4.4 Fourth Variation

Although not shown, any one, two, three, or four of the first connecting portion 1171, the second connecting portion 1172, the third connecting portion 1173, and the fourth connecting portion 174 may not be a curved surface but a bent surface. The bent surface includes an approximately L shape in the cross sectional view.

### 4.5 Fifth Variation

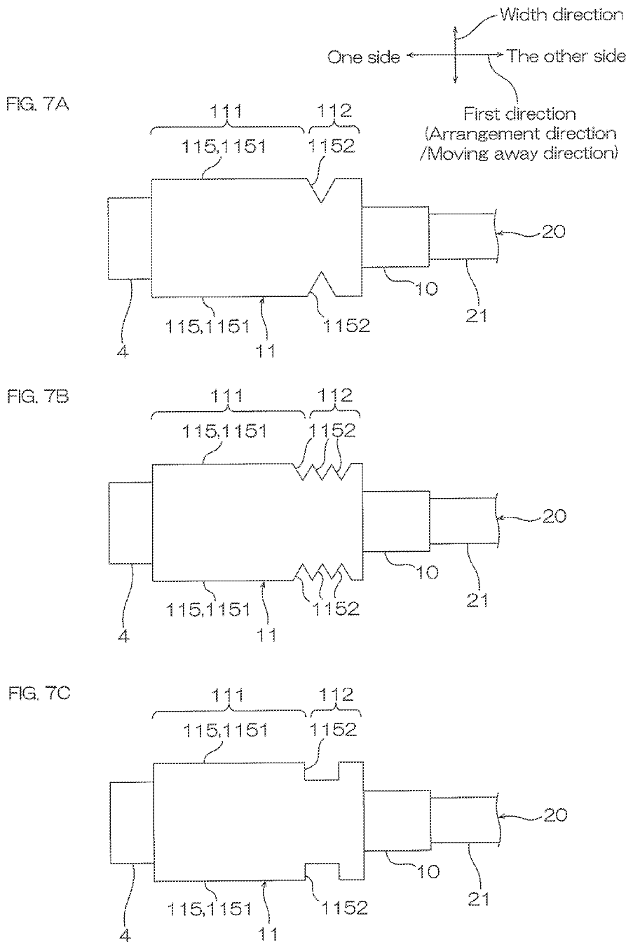

The shape and number of the concave portion(s) 1152 are not limited. In the fifth variation, as shown in FIG. 7A, the concave portion 1152 has an approximately triangular shape.

As shown in FIG. 7B, the number of the concave portions 1152 on one side wall 115 is plural (three).

As shown in FIG. 7C, the concave portion 1152 has an approximately rectangular shape.

### 4.6 Sixth Variation

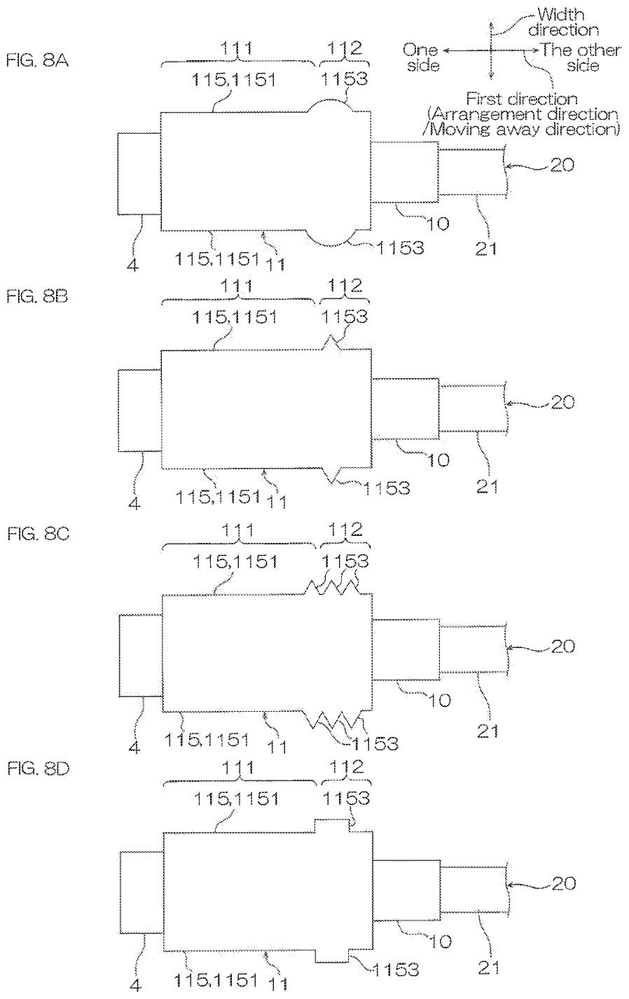

As shown in FIG. 8A to FIG. 8D, the second wall 114 has a convex portion 1153 in place of the concave portion 1152. The convex portion 1153 protrudes toward the outside in the width direction.

As shown in FIG. 8A, the convex portion 1153 has an approximately arc (semicircular arc) shape in the plan view.

As shown in FIG. 8B, the convex portion 1153 has an approximately triangular shape.

As shown in FIG. 8C, the number of the convex portions 1153 on one side wall 115 is plural (three).

As shown in FIG. 8D, the convex portion 1153 has an approximately rectangular shape.

### 4.7 Seventh Variation

In the seventh variation, although not shown, the first intermediate surface 117 and the second intermediate surface 118 are inclined relative to the thickness direction. For example, the first intermediate surface 117 is inclined toward the other side in the first direction as it approaches in the direction away from the second wall 114 in the thickness direction. Furthermore, the second intermediate surface 118 is inclined toward the other side in the first direction as it approaches in the direction away from the first wall 113 in the thickness direction. In other words, in the seventh variation, the first intermediate surface 117 and the second intermediate surface 118 form a tapered shape in which a facing distance between the first intermediate surface 117 and the second intermediate surface 118 becomes gradually longer toward the other side in the first direction.

### 4.8 Eighth Variation

In the optical cable 2 of the eighth variation, one of the photoelectric conversion module plugs 1 may be the above-described photoelectric conversion module plug of the present invention while the other photoelectric conversion module plug 1 may be a photoelectric conversion module plug that is not the present invention.

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The photoelectric conversion module plug is used for an optical cable.

### DESCRIPTION OF REFERENCE NUMERALS

1 photoelectric conversion module plug
2 optical cable
3 PCB (an example of a circuit board)
4 electrical connector
5 board connector
6 opto-electric hybrid board
7 photonic device
8 optical fiber
10 boot
11 casing
20 cable
72 circuit
91 first device
92 second device
111 thin portion
112 thick portion
113 first wall
114 second wall
115 side wall
117 first intermediate surface (an example of a surface)
118 second intermediate surface (an example of a surface)
612 core
1131 first portion
1132 second portion
1133 first surface
1134 second surface
1152 concave portion
1153 convex portion
1171 first connecting portion
1172 second connecting portion
1173 third connecting portion
1174 fourth connecting portion
6121 mirror surface

1. A photoelectric conversion module plug comprising:
a circuit board;
an electrical connector electrically connected to the circuit board and capable of being inserted into an external device;
an opto-electric hybrid board disposed one side in a thickness direction of the circuit board and electrically connected to the circuit board;
an optical fiber optically connected to the opto-electric hybrid board;
a photonic device mounted on the opto-electric hybrid board; and
a casing accommodating the circuit board, a part of the electrical connector, the opto-electric hybrid board, a part of the optical fiber, and the photonic device,
wherein the opto-electric hybrid board includes a core optically connected to the optical fiber,
wherein the core includes a mirror surface optically connected to the photonic device,
wherein the electrical connector and the optical fiber are separately arranged in an orthogonal direction to the thickness direction,
wherein the casing includes a first wall and a second wall that face each other at an interval in the thickness direction, and
wherein the first wall has a surface extending in a direction away from the second wall in the thickness direction and faces the electrical connector side in the arrangement direction.

2. The photoelectric conversion module plug according to claim 1,
wherein the casing has:
a thin portion; and
a thick portion thicker than the thin portion,
wherein the first wall has:
a first portion included in the thin portion and facing a part of the electrical connector in the thickness direction; and
a second portion included in the thick portion and facing a part of the optical fiber in the thickness direction, and
wherein the surface is disposed between the first portion and the second portion in the orthogonal direction.

3. The photoelectric conversion module plug according to claim 2,
wherein a difference in thickness between the thick portion and the thin portion is 0.1 mm or more and 5 mm or less.

4. The photoelectric conversion module plug according to claim 2, further comprising:
a boot that attaches a cable having the optical fiber to the casing,
wherein the boot faces the second portion in the thickness direction.

5. The photoelectric conversion module plug according to claim 2,
wherein the first portion has a first surface facing in the away direction, and
wherein a connecting portion of the first surface and the surface has a curved surface.

6. The photoelectric conversion module plug according to claim 2,
wherein the second portion has a second surface facing in the away direction, and
wherein a connecting portion of the second surface and the surface has a curved surface.

7. The photoelectric conversion module plug according to claim 5,
wherein the curved surface has a radius of curvature of 1 μm or more and 50 mm or less.

8. The photoelectric conversion module plug according to claim 1,
wherein the second wall has a surface extending in a direction away from the first wall in the thickness direction and facing the electrical connector side in the arrangement direction.

9. The photoelectric conversion module plug according to claim 1,
wherein the casing has two side walls joining both end portions in a width direction orthogonal to the thickness direction and the away directions of the first wall and the second wall, and
wherein the two side walls has a concave portion and/or a convex portion.

10. An optical cable comprising:
two photoelectric conversion module plugs; and
a cable that optically connects the two photoelectric conversion module plugs,
wherein at least one of the two photoelectric conversion module plugs is the photoelectric conversion module plug according to claim 1.

11. The photoelectric conversion module plug according to claim 3, further comprising:
a boot that attaches a cable having the optical fiber to the casing,
wherein the boot faces the second portion in the thickness direction.

12. The photoelectric conversion module plug according to claim 3,
wherein the first portion has a first surface facing in the away direction, and
wherein a connecting portion of the first surface and the surface has a curved surface.

13. The photoelectric conversion module plug according to claim 3,
wherein the second portion has a second surface facing in the away direction, and
wherein a connecting portion of the second surface and the surface has a curved surface.

14. The photoelectric conversion module plug according to claim 12,
wherein the curved surface has a radius of curvature of 1 μm or more and 50 mm or less.

15. The photoelectric conversion module plug according to claim 2,
wherein the second wall has a surface extending in a direction away from the first wall in the thickness direction and facing the electrical connector side in the arrangement direction.

16. The photoelectric conversion module plug according to claim 2,
wherein the casing has two side walls joining both end portions in a width direction orthogonal to the thickness direction and the away directions of the first wall and the second wall, and
wherein the two side walls has a concave portion and/or a convex portion.

17. An optical cable comprising:
two photoelectric conversion module plugs; and
a cable that optically connects the two photoelectric conversion module plugs,
wherein at least one of the two photoelectric conversion module plugs is the photoelectric conversion module plug according to claim 2.
